(19) United States
(12) Patent Application Publication
(10) Pub. No.: US 2024/0399484 A1
(43) Pub. Date: Dec. 5, 2024

(54) TORCH MOTION SENSOR ACTUATION OF AUXILIARY FEATURES

(71) Applicant: ESAB AB, Gothenburg (SE)

(72) Inventors: Marc Hartel, Reiskirchen (DE); Ulrich Kaldenbach, Gruenberg (DE); Azfar Kamal, Frisco, TX (US)

(21) Appl. No.: 18/800,284

(22) Filed: Aug. 12, 2024

Related U.S. Application Data
(63) Continuation of application No. PCT/IB2023/051376, filed on Feb. 15, 2023.
(60) Provisional application No. 63/310,630, filed on Feb. 16, 2022.

(51) Int. Cl. B23K 9/095; B23K 9/32

(52) U.S. Cl. CPC B23K 9/0956; B23K 9/0953; B23K 9/32

(57) ABSTRACT

Presented herein are techniques for activating auxiliary features of an arc process system when a controller determines a torch is in a user's hand. The controller will determine, via a motion sensor in the torch, when the torch moves and/or a user picks up and handles the torch. Once the system detects motion of the torch, the system may automatically activate auxiliary features of the system in anticipation of arc initiation.

### CROSS-REFERENCE TO RELATED APPLICATION

This application is a continuation of International App. No. PCT/IB2023/051376, which was filed on Feb. 15, 2023, and which claims priority to U.S. Provisional Application No. 63/310,630, filed Feb. 16, 2022, the entirety of each of which is incorporated herein by reference.

### TECHNICAL FIELD

The present disclosure relates to welding and plasma cutting systems, and in particular, a system configured to actuate auxiliary features in response to detection of torch motion.

### BACKGROUND

Conventional arc process systems include an arc process torch (e.g., welding and plasma cutting torch) connected to a power supply. The primary function of the power supply is to provide and control power to the torch for an arc process operation (e.g., a welding or plasma cutting operation). The power supply may include one or more auxiliary components that provide one or more auxiliary functions. For example, the power supply may control or provide flows of cooling fluid and process/shield gas to the torch. As another example, a cooling fan within the power supply may cool components therein. Typically, these features are initiated in response to a user activating each auxiliary component/feature (e.g., with a switch or via a user interface) prior to arc initiation. Each auxiliary feature, generally, requires some lead time before an arc can be initiated. For example, in some instances, a fluid pump (e.g., water pump) must fill a cable and torch with a flow of cooling fluid prior to arc initiation. As a further example, in some instances, one or more valves may activate to charge the cable and torch with one or more process/shield gases prior to arc initiation. Lastly, in some instances, a fan must induce a flow of cooling air through the power supply to cool power supply components and prevent overheating prior to arc initiation. Consequently, when a user is ready to initiate an arc process, a user must walk over to the devices of the arc process system, activate each auxiliary component/feature, wait for the lead time for each feature and walk back to the torch resulting in significant delays to initiate an arc.

### SUMMARY

The techniques presented herein activate auxiliary features of an arc process system when a controller determines a torch is in a user's hand and/or being imparted with motion. The controller will detect via a motion sensor in the torch when a user picks up and handles/manipulates the torch. Once the system determines the torch is moving, the system automatically activates auxiliary features of the system in anticipation of arc initiation. For example, prior to arc initiation, the controller could activate a fluid pump for providing cooling flow of fluid (e.g., water) to the torch, activate a cooling fan to cool components of the power supply, and/or initiate one or more flows of process and/or shield gases to the torch. The above examples are not intended to be limiting, and the controller may be configured to activate and/or deactivate any component of any connected device of the arc process system.

The techniques described herein relate to a torch including: a trigger assembly; a controller electrically coupled to the trigger assembly; and a motion sensor electrically coupled to the controller, wherein the controller is configured to transmit a control signal to one or more components of an arc process system in response to motion detected by the motion sensor.

In some instances, the motion sensor is configured to detect motion of the torch and transmit a motion signal indicative of motion of the torch to the controller. The controller may determine whether the torch is in a user's hand based on the motion signal from the motion sensor.

In some implementations, the one or more components include a pump for supplying cooling liquid to the torch, a cooling fan to induce a cooling flow through an interior of a power supply, a gas manifold to charge a gas line fluidly coupled to the torch, a light source, and a trigger for controlling an arc process operation. The control signal may activate or deactivate the one or more components.

In some aspects, the trigger assembly further includes a trigger; and the controller is further configured to prevent the trigger from transmitting a signal when the controller determines the torch is not in motion.

In some instances, the controller may be further configured to determine the torch is held in a user's hand based on a motion signal from the motion sensor.

In some aspects, the techniques described herein relate to a method including: generating, via a motion sensor, a motion signal indicative of motion of a torch; transmitting, via the motion sensor, the motion signal to a controller; receiving the motion signal at the controller; determine, via the controller, whether the torch is moving based on the received motion signal; and transmitting, via the controller, a control signal to one or more components of an arc process system to activate one or more auxiliary functions.

In some implementations, the one or more components include a pump, a cooling fan, a gas manifold, a light source, and a trigger for controlling an arc process operation. The one or more auxiliary functions may include at least one of: supplying cooling liquid to the torch via the pump; inducing a cooling flow through an interior of a power supply of the arc process system via the cooling fan; illuminating an area via the light source; charging a gas line fluidly coupled to the torch via the gas manifold; and a trigger safety for the trigger.

In some aspects, the one or more auxiliary functions include a trigger safety, the trigger safety includes preventing the trigger from sending an activation signal to the one or more components.

In some instances, the one or more auxiliary functions are activated prior to initiation of an arc.

In some aspects, the techniques described herein relate to a system including: an arc process device including one or more components; a controller electrically coupled to the arc process device; and a motion sensor electrically coupled to the controller, wherein the controller is configured to control to the one or more components of the arc process device in response to a motion signal from the motion sensor.

In some implementations, the arc process device is a torch, and the one or more components is a trigger. The controller may be further configured to prevent the trigger from initiating an arc process operation based on the motion signal. The controller may be further configured to allow the trigger to initiate an arc process operation based on the motion signal, and the motion signal may be indicative of the torch being held in a user's hand. The motion sensor and the trigger may be disposed in a trigger assembly. Additionally, or alternatively, the motion sensor may be disposed in the torch body.

In some instances, the one or more components include at least one of a pump for supplying cooling liquid to a torch, a cooling fan to induce a cooling flow through an interior of a power supply, a light source for illuminating an area, and a gas manifold to charge a gas line fluidly coupled to the torch. The arc process device may include at least one of the power supply, a wire feeder, a cooling unit, a gas supply and/or the torch.

### BRIEF DESCRIPTION OF THE DRAWINGS

To complete the description and in order to provide for a better understanding of the techniques presented in this application, a set of drawings is provided. The drawings form an integral part of the description and illustrate an embodiment of the present application, which should not be interpreted as restricting the scope of the present application, but just as an example of how the techniques presented herein can be carried out. The drawings comprise the following figures:

FIG. 1A is a perspective view of a torch, according to an embodiment.

FIG. 1B is a schematic of a power supply according to an embodiment.

FIG. 2A is an exploded view of the torch of FIG. 1A with a side portion removed.

FIG. 2B is a perspective view of a trigger module of the torch of FIG. 1A.

FIG. 3 is a block diagram of a method for controlling an auxiliary feature/component of a device of an arc process system.

FIG. 4 is a hardware block diagram of a computing device.

Like reference numerals have been used to identify like elements throughout this disclosure.

### DESCRIPTION OF EXAMPLE EMBODIMENTS

The following description is not to be taken in a limiting sense but is given solely for the purpose of describing the broad principles of the invention. Embodiments of the invention will be described by way of example, with reference to the above-mentioned drawings showing elements and results according to the present invention.

Generally, a torch, as presented herein, includes a trigger assembly or module that is removably coupled to the torch. For example, the trigger module includes a housing defining a cavity for receiving an accessory such as a motion sensor, a light source, and/or a temperature sensor. Regardless of the accessories included in the trigger module, electrically coupling the trigger module to the torch results in the trigger and one or more accessories being operably coupled to the torch. A cable electrically couples the torch (and thus, the one or more accessories) to other devices of an arc process system (e.g., a power supply, a wire feeder, etc.). The motion sensor can transmit signals indicative of movement of the torch to a controller disposed in the torch, the power supply, and/or any other device of the arc process system. The controller may activate auxiliary systems of the torch, the power supply, and/or of other arc process system devices in response to receiving a signal from the motion sensor. For example, prior to arc initiation, the controller could receive a signal from the motion sensor and activate a light source in the torch for illuminating an area, a fluid pump for providing cooling flow of fluid (e.g., water) to the torch, activate a cooling fan to cool components of the power supply, activate a feeder motor for feeding weld wire, and/or activate a gas manifold to initiate one or more flows of one or more process/shield gases to the torch, thereby charging a gas line within the cable and torch with the one or more process/shield gases for an arc process. In some implementations, the fluid pump, feeder motor, and/or the gas manifold are part of the power supply. In some implementations, the fluid pump, feeder motor, and/or the gas manifold are components disposed in separate arc process devices such as a cooling unit, wire feeder, and/or gas supply operably coupled to the power supply. In some implementations, the motion sensor may be disposed in the torch body (e.g., a torch handle, a torch neck, etc.) and electrically coupled to the controller.

Additionally, or alternatively, the motion sensor could control a safety mechanism to prevent unintentional activation of the trigger. The trigger safety may be a component that determines whether a signal from activation of the trigger is transmitted, or a circuit or a switch that de-energizes a portion of the trigger to prevent the trigger from generating a signal. For example, the controller may prevent the trigger from sending a signal to an arc process device (e.g., power supply, wire feeder, fluid pump/water pump, gas manifold, cooling fan, etc.) until the controller receives a motion signal from the motion sensor. Alternatively, a controller may ignore a signal from the trigger until a motion signal is received from the motion sensor. Regardless of the specific implementation of the safety mechanism, actuation of the trigger cannot initiate or activate an arc process operation until the controller determines that the torch is being held by a user (or is otherwise moving) based on the signal from the motion sensor.

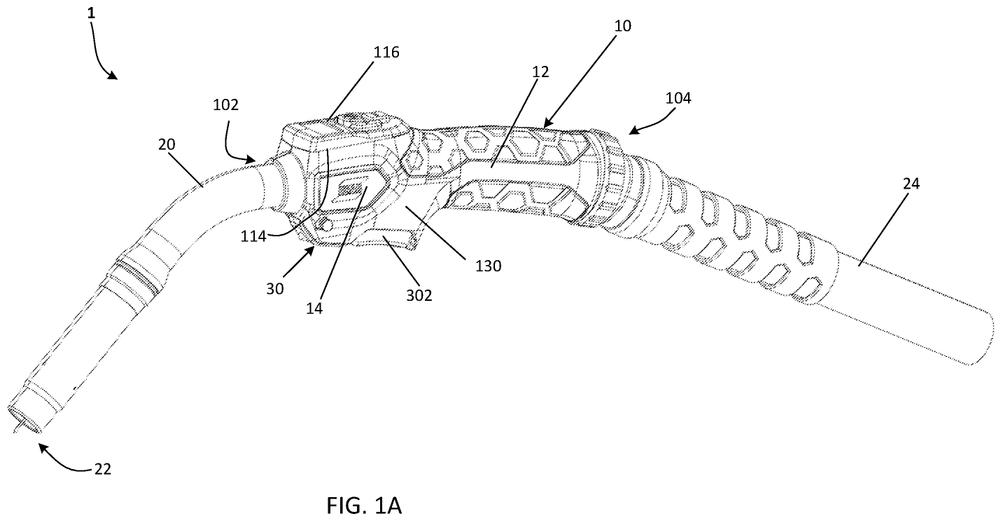

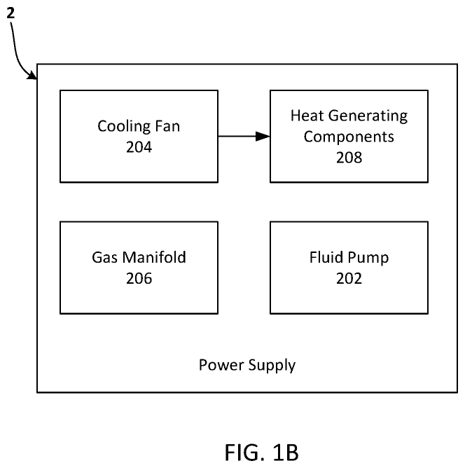

Now referring to FIGS. 1A and 1B, a torch 1 and power supply 2 of an arc process system according to an exemplary embodiment are described. While not illustrated, an arc process system may include any other device (e.g., wire feeder, cooling unit, gas supply, etc.) in addition to the illustrated torch 1 and power supply 2. The torch 1 includes a handle 10, torch neck 20, and a trigger assembly or module 30 having a trigger 302. The handle 10 has a front end 102 and back end 104 opposite the front end 102. The torch neck 20 extends from the front end 102 to a torch tip 22. A cable 24 is connected to the handle 10 at the back end 104 and is configured to electrically and fluidly couple the torch 1 to the power supply 2 and/or any other arc processing system components. For example, the cable 24 is configured to provide/deliver control signals, process current, weld wire, and/or one or more fluids (e.g., process gas, shield gas, and cooling fluid) between the torch 1 and the power supply 2 (or any other device in the processing system). The cable 24 may include one or more conduits and a plurality of conductors. The one or more conduits direct the one or more fluids between the torch 1 and the power supply 2. Weld wire may also be fed through the one or more conduits from the power supply 2 (or a wire feeder) to the torch 1. The plurality of conductors conduct the one or more control signals and a process current between the torch 1 and the power supply 2.

The power supply 2 may include a fluid pump 202, a cooling fan 204, and a process/shield gas manifold 206. The fluid pump 202 is configured to pump a flow of cooling fluid (e.g., water) from a reservoir in, or fluidly coupled to, the power supply 2, through the cable 24 to the torch 1. The flow of cooling fluid cools components of the torch 1 before circulating back through the cable 24 to the reservoir. In some implementations, the fluid pump 202 is separate from the power supply 2, but electrically and fluidly coupled to the power supply 2 such that the power supply 2 may control the fluid pump 202.

The cooling fan 204 is configured to induce a flow of cooling air from the ambient environment around the power supply 2 through an interior of the power supply 2. The flow of cooling air flows through heat generating components 208 disposed inside a housing of the power supply 2. The heat generating components 208 may include one or more of a transformer, a voltage booster circuit, an AC-DC converter circuit, a controller and/or other control circuits, etc. The flow of cooling air dissipates heat from the heat generating components 208 by capturing the heat from the components, and carrying the heat out of the power supply 2 to the ambient environment.

The gas manifold 206 may include one or more valves configured to control one or more flows of one or more process gases and/or shield gases from a gas supply through the cable 24 to the torch 1. For example, the one or more valves may be opened to allow one or more process gases and/or shield gases to flow from one or more gas sources to charge, or fill, the internal conduit of the cable 24 and the torch 1 with the one or more process gases and/or shield gases. The gas sources may be disposed in or fluidly coupled to the power supply 2. Prior to arc initiation, any contaminant (e.g., fluid, oxygen, air, oil, debris, etc.) in the cable 24 and/or torch 1 may be flushed out by the one or more process and/or shield gasses to prevent contamination of the weld seam. In some implementations, the gas manifold 206 may be external to the power supply 2, and electrically and/or fluidly coupled to the power supply 2, such that the power supply may control the gas manifold 206. In some implementations, the gas manifold 206 may be disposed in a wire feeder operably coupled to the power supply 2. Moreover, the torch 1 may include one or more valves to control one or more flows of one or more gases received from the manifold 206.

In some implementations, the power supply 2 may include an integrated wire feeder. In another implementation, the power supply 2 may be electrically coupled to a wire feeder which, in turn, transmits arc process current to and/or transmits/receives control signals to/from the torch 1 via the cable 24. That is, the torch 1 may be electrically and fluidly coupled to the wire feeder which may be electrically and fluidly coupled to the power supply 2.

Referring to FIG. 1A, the handle 10 includes a grip portion 12 and a main body portion 14. The grip portion 12 has a generally cylindrical shape and is configured to be gripped by a user during operation. The main body portion 14 includes a control module seat 114 for receiving a control module 116, and a receiving portion 130 that protrudes towards a bottom of the main body portion 14. The receiving portion 130 is configured to receive and retain the trigger module 30.

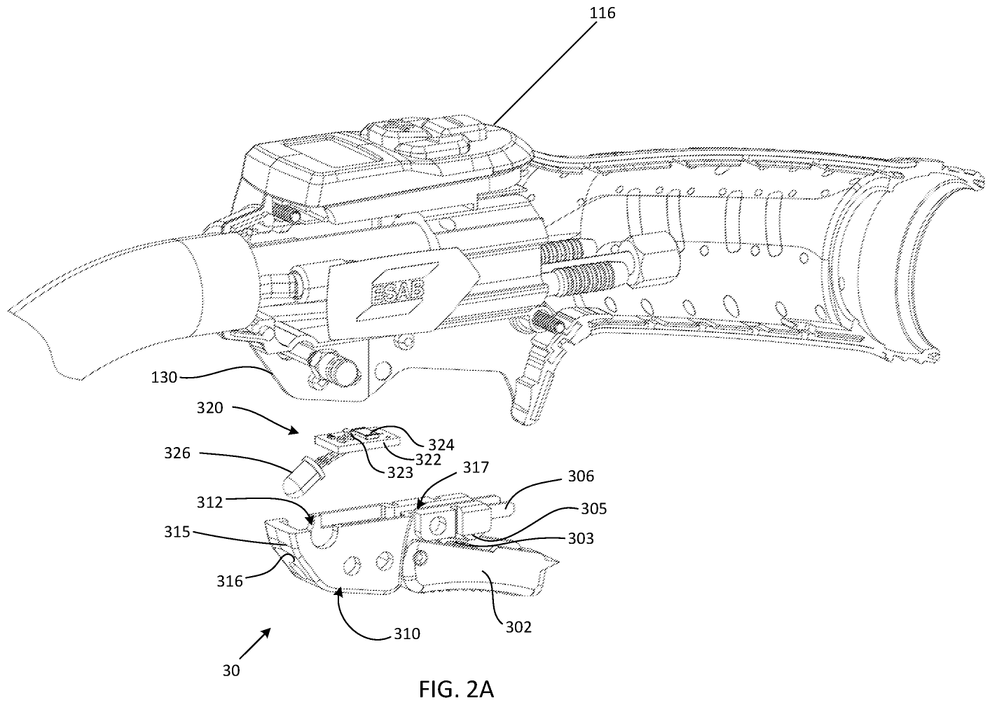

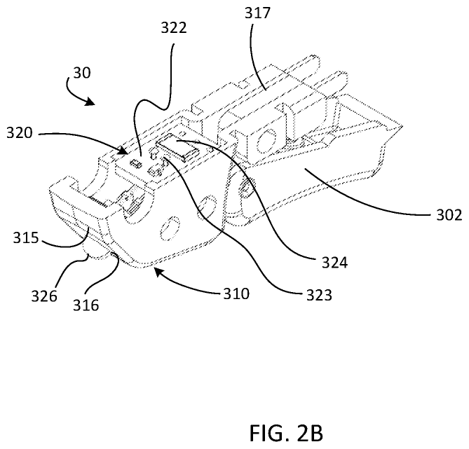

Referring to FIG. 2A, an exploded view of the torch 1 with a side portion removed and of the trigger module 30 is illustrated. The trigger module 30 includes a housing 310 defining a cavity 312. The housing 310 includes a front wall 315 and a tail portion 317 for receiving the trigger 302. That is, the trigger 302 is operably coupled to the housing 310 via the tail portion 317 such that the trigger 302 rotates with respect to the housing 310 and the tail portion 317. In other embodiments, the trigger 302 may translate with respect to the housing 310 and the tail portion 317. The trigger 302 includes a trigger contact 303 configured to engage a base contact 305 through rotation, translation, or another type of movement of the trigger 302. When the trigger contact 303 touches the base contact 305, a circuit is completed thereby initiating, maintaining, or deactivating an arc process. The trigger module 30 further includes an electrical component 320 disposed substantially in the cavity 312 of the housing 310. That is, portions of the electrical component 320 may protrude from or otherwise extend beyond the cavity 312 of the housing 310. The electrical component 320 is configured to activate auxiliary functions of the power supply 2, torch 1, or any other device of the arc process system in response to determining the torch 1 is being handled by a user.

The electrical component 320 may include a printed circuit board (PCB) 322, one or more accessories such as one or more electrical modules 324, and/or a light source 326. The one or more electrical modules 324 includes a motion sensor configured to detect movement of the torch 1. The light source 326 is configured to emit a light at the torch tip 22 to illuminate an area or location of a desired weld or cut. The one or more electrical modules 324 and the light source 326 are electrically coupled to the PCB 322. The PCB 322 may be electrically coupled to the power supply 2, terminals 306, contacts 303 and 305, and/or the control module 116 via PCB contacts 323. For example, the contacts 323 may be attached to internal wiring or circuitry (not shown) of the torch 1 and/or cable 24. Consequently, the PCB 322 is configured to communicate with (and/or provide communication between) the trigger 302, the one or more electrical modules 324, a control module at the torch 1 (e.g., control module 116), the power supply 2, and/or any other connected device of the arc process system.

As illustrated in FIG. 2B, the electrical component 320 is received in the cavity 312 of the housing 310 of the trigger module 30. The housing 310 cradles the electrical component 320 and prevents it from moving within the cavity 312. The light source 326 extends from the PCB 322 to the front wall 315 and partially through a front-facing hole 316 in the front wall 315.

During operation, the PCB 322 may control an auxiliary function of the arc process system based on operation of the torch 1, and/or trigger module 30. More specifically, the motion sensor may detect movement (and subsequently non-movement) of the torch 1 in response to a user picking up or otherwise handling the torch 1, and may transmit a signal indicative of movement of the torch 1 to a controller in the torch 1, the power supply 2, and/or any other connected device of the arc process system. For example, the controller may receive the signal indicative of movement of the torch 1 from the motion sensor. In response to receiving the signal, the controller may transmit a control signal to initiate and/or deactivate the trigger 302 and/or one or more auxiliary components such as a fluid pump, a cooling fan, a gas valve and/or the light source 326. Specifically, the control signal may (1) deactivate a safety for the trigger 302 such that a signal may be transmitted in response to the trigger contact 303 contacting the base contact 305 (2) activate a fluid pump to induce a flow of cooling fluid from a reservoir to the torch 1, (3) activate a cooling fan disposed in the power supply 2 to induce a flow of cooling air through the housing of the power supply 2 to cool the heat generating components 208 of the power supply 2 and back out to the ambient environment, (4) actuate one or more valves to initiate one or more flows of process/shield gases to the torch 1 thereby pre-charging one or more conduits and/or torch 1 with the one or more process/shield gases and flushing out any contaminant (e.g., fluid, oxygen, air, oil, debris, etc.) that may contaminate a weld seam, and/or (5) activate and/or deactivate the light source 326 disposed in the torch 1. The activation or deactivation of these features may occur before arc initiation.

The trigger safety may be implemented in any suitable manner. For example, the trigger safety be a component or setting within the controller that may de-energize the trigger contact 303 and/or the base contact 305 to prevent a signal from conducting therebetween. Additionally, or alternatively, the trigger safety may prevent the controller from activating/initiating an arc process operation in response to receiving a signal indicative of the trigger contact 303 contacting the base contact 305. Regardless of how the trigger safety prevents the trigger 1 from activating or initiating an arc process, the trigger safety is deactivated based on a signal from the motion sensor indicative of movement of the torch. Deactivation of the trigger safety may further be based on whether the motion sensor transmits a signal indicative of constant motion (e.g., when the torch his held in hand) or of a short duration (e.g., the torch has been jostled, dropped, or laid to rest). For instance, the trigger safety may only be deactivated in response to a signal indicative of the torch 1 being held in a user's hand and, thus, allow the trigger to activate an arc process operation. Moreover, the trigger safety may remain activated or be reactivated in response to the motion sensor indicating the torch has been jostled, dropped, or otherwise laid to rest (E.g., placed on a surface, hung from a mount, or otherwise placed in a holder for storage).

The above examples are not intended to be limiting. Thus, in addition to the examples listed above, the control signal may be configured to activate and/or deactivate any other component of any connected device of the arc process system. While the one or more electrical modules 324, including one or more motion sensors, are depicted as disposed in the trigger module 30 housing 310, embodiments are not limited thereto. For example, one or more motion sensors may be disposed in the handle 10, the grip portion 12, the main body portion 14, and/or the torch control module 116.

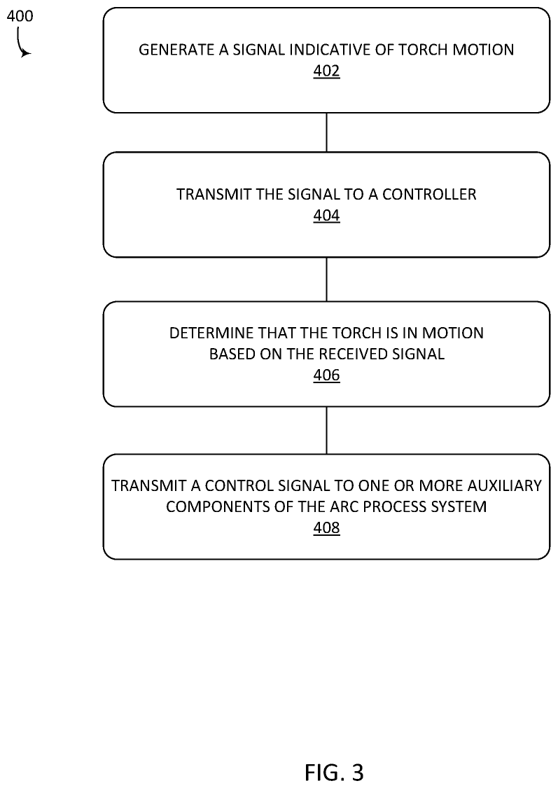

Now referring to FIG. 3, a block diagram depicting a method 400 for controlling an auxiliary feature/component of an arc process system. The method 400 includes generating a signal indicative of movement of the torch in operation 402, transmitting the signal to a controller in operation 404, determining that the torch is in motion based on the received signal in operation 406, and transmitting a control signal to one or more auxiliary components of the arc process system in operation 408.

In operation 402, a motion sensor generates a signal indicative of movement of the torch prior to arc initiation. When the torch is held in the user's hand or otherwise being moved for an arc processing operation, there is constant motion that the sensor detects and registers as movement, no matter how subtle. Thus, regardless of whether the user is actively moving the torch, or simply holding the torch as still possible, the motion sensor will generate the motion signal. If the torch is put on a stable surface or placed in a storage holder, the motion sensor will register no movement and either generate corresponding a signal, or no signal.

In operation 404, the motion sensor transmits the signal to a controller. As previously explained, the controller may be disposed within the torch, the power supply, or any other device of the arc process system. In operation 406, the controller determines that the torch is in motion based on the signal received from the motion sensor. For example, based on the signal, the controller may determine whether the torch is in a user's hand, or was merely jostled and is again stationary. The motion signal corresponds to both the active use of the torch and the subtle movement of the torch while in the user's hand. Meanwhile the lack of signal may correspond to the torch being at rest. The determination may further include a time component to distinguish the torch being picked up by a user's hand versus being accidently jostled or dropped. For example, the controller may time how long a signal indicative of movement was received before determining the torch is in the user's hand. For instance, the controller may wait to receive a motion signal that lasts at least 1-2 seconds before determining that the torch is in the user's hand. Similarly, the torch may have a short time window to determine that the torch has been set down, e.g., about 1 second. Accordingly, the controller may determine whether the torch is in the user's hand, has been set to rest for storage, or has been inadvertently moved or jostled.

In operation 408, the controller sends a control signal to one or more auxiliary components of the arc process system. For example, the one or more auxiliary components may include one or more cooling fans, liquid or water pumps, gas manifolds (e.g., one or more gas valves), liquid manifolds (e.g., one or more water valves), feeder motors, lights (e.g., light emitting diodes), and/or other components connected to/forming part of the arc process system. The one or more auxiliary components may further include a trigger safety as described above. The controller may activate the safety (e.g., de-energize the trigger) in response to determining that the torch is no longer in the user's hand (e.g., has been dropped or otherwise set down for storage). In some implementations, the auxiliary components are disposed in one or more devices connected to the arc process system. For example, the one or more devices may include a torch, a power supply, a fluid cooling unit, a wire feeder, a gas supply, and/or other device connected to the arc process system.

Accordingly, in response to receiving a signal indicative of motion from the motion sensor, the controller activates one or more auxiliary components of an arc process system. For example, the controller may activate a cooling fan 204, a gas manifold 206, and/or a fluid pump 202 in response to receiving the signal indicative of motion. The cooling fan 204 may cool heat generating components 208 (e.g., transformers, voltage boosters, converters, etc.) of the power supply 2. The gas manifold 206 may provide a flow of shield and or process gas through a cable 24 to a torch 1 to charge the system with shield/process gas prior to arc initiation. The fluid pump 202 may provide a flow of cooling liquid (e.g., water) through the cable 24 to the torch 1 prior to arc initiation. The light source 326 may be activated for a set duration, or until arc initiation. For example, the controller may activate the light source 326 to radiate light for 30 seconds each time signal indicative of motion is received. Additionally or alternatively, after arc initiation, the controller may deactivate the light source 326 until the arc is extinguished.

However, in some instances, the controller may not activate the primary components of the power supply (e.g., electronics that provide process power to the torch 1 for an arc process) in response to the signal. Rather, the controller may simply activate the auxiliary functions of the system in preparation for activation of the primary components of the power supply 2 (e.g., transformers, voltage boosters, converters, control electronics etc.). Consequently, the arc process system may be ready after a user handles the torch 1, and individual activation of each auxiliary component is not required prior to arc initiation for an arc process operation.

Moreover, the controller may deactivate the auxiliary components in response to determining the torch is not (or no longer) in the user's hand. For example, the motion sensor may determine that the torch is no longer moving for a period of time and transmit a signal, or may cease transmitting a signal, indicative of the torch being at rest. In response to determining the torch is not in the user's hand, the controller may activate a trigger safety to prevent signals from the trigger 302 from activating, initiating, or otherwise controlling a parameter of an arc process operation. Further, the controller may deactivate the light source 326 and the gas manifold 206 to prevent plasma and/or shield gases from flowing to the torch 1.

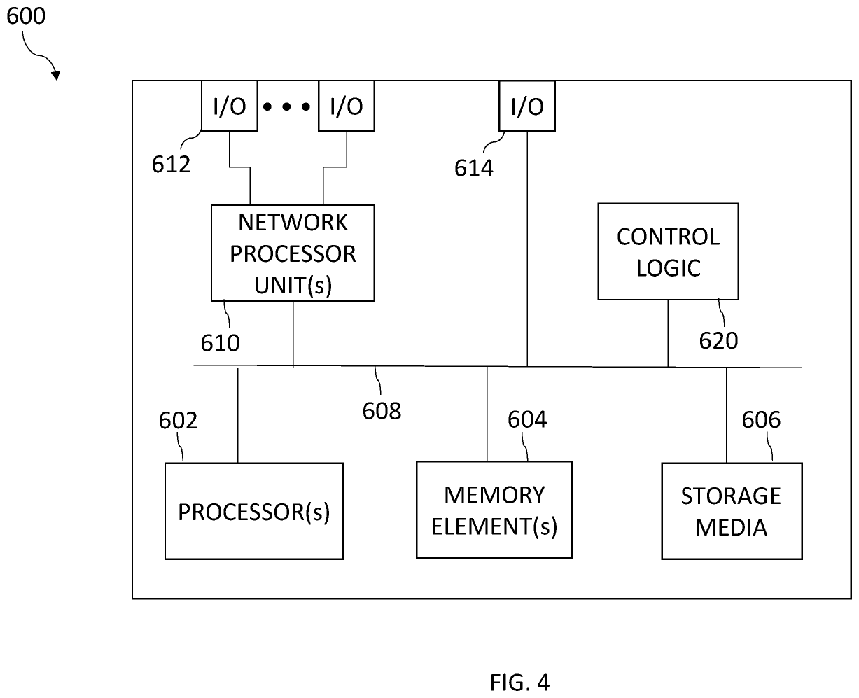

Referring to FIG. 4, a hardware block diagram of a computing device 600 is illustrated. The illustrated computing device 600 may be an example of a controller as described above. The computing device 600 may perform functions associated with the operations discussed herein in connection with the techniques described herein with reference to FIGS. 1A-3. The computing device 600 may be incorporated in any of the arc process system devices discussed herein, and may be configured to perform the operations discussed herein for determining motion of the torch 1 and controlling operation of the auxiliary components of the devices of the arc process system based on the detected torch motion.

In at least one embodiment, the computing device 600 may be any apparatus that may include one or more processor(s) 602, one or more memory element(s) 604, storage media 606, a bus 608, one or more network processor unit(s) 610 interconnected with one or more network input/output (I/O) interface(s) 612, one or more I/O interface(s) 614, and control logic 620. In various embodiments, instructions associated with logic for the computing device 600 can overlap in any manner and are not limited to the specific allocation of instructions and/or operations described herein.

In at least one embodiment, the processor(s) 602 is/are at least one hardware processor configured to execute various tasks, operations and/or functions for the computing device 600 as described herein according to software and/or instructions configured for the computing device 600. The processor(s) 602 can execute any type of instructions associated with data to achieve the operations detailed herein. In one example, the processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term “processor”.

In at least one embodiment, the memory element(s) 604 and/or the storage media 606 is/are configured to store data, information, software, and/or instructions associated with the computing device 600, and/or logic configured for the memory element(s) 604 and/or the storage media 606. For example, any logic described herein (e.g., the control logic 620) can, in various embodiments, be stored for the computing device 600 using any combination of the memory element(s) 604 and/or the storage media 606. Note that in some embodiments, the storage media 606 can be consolidated with memory element(s) 604 (or vice versa), or can overlap/exist in any other suitable manner.

In various embodiments, any entity, apparatus, or device as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad terms “memory element” and “storage media.” Data/information being tracked and/or sent to one or more entities, apparatuses, or devices as discussed herein could be provided in any database, table, register, list, cache, storage, and/or storage structure: all of which can be referenced at any suitable timeframe. Any such storage options may also be included within the broad terms “memory element” and “storage media” as used herein.

Note that in certain example implementations, operations as set forth herein may be implemented by logic (as described herein; e.g., the control logic 620) encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by the one or more processor(s) 602, and/or other similar machine(s), etc. Generally, this includes the memory element(s) 604 and/or the storage media 606 being able to store data, software, code, instructions (e.g., processor instructions), logic (e.g., the control logic 620), parameters, combinations thereof, or the like that are executed to carry out operations in accordance with teachings of the present disclosure.

To the extent that embodiments presented herein relate to the storage of data, the embodiments may employ any number of any conventional or other databases, data stores or storage structures (e.g., files, databases, data structures, data or other repositories, etc.) to store information.

In at least one embodiment, the bus 608 can be configured as an interface that enables one or more elements of the computing device 600 to communicate in order to exchange information and/or data. The bus 608 can be implemented with any architecture designed for passing control, data and/or information between the processor(s) 602, the memory elements 604, the storage media 606, peripheral devices, and/or any other hardware and/or software components that may be configured for the computing device 600. In at least one embodiment, the bus 608 may be implemented as a fast kernel-hosted interconnect, potentially using shared memory between processes (e.g., logic), which can enable efficient communication paths between the processes.

In various embodiments, the network processor unit(s) 610 may enable communication between the computing device 600 and other systems, entities, devices, etc., via the network I/O interface(s) 612 (wired and/or wireless) to facilitate operations discussed for various embodiments described herein. In various embodiments, the network processor unit(s) 610 can be configured as a combination of hardware and/or software, such as one or more Ethernet driver(s) and/or controller(s) or interface cards, Fiber Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between the computing device 600 and other arc process system devices, arc process system auxiliary components, etc. to facilitate the operations described herein. In various embodiments, the network I/O interface(s) 612 can be configured as one or more Ethernet port(s), Fiber Channel ports, any other I/O port(s), and/or antenna(s)/antenna array(s) now known or hereafter developed. Thus, the network processor unit(s) 610 and/or the network I/O interface(s) 612 may include suitable interfaces for receiving, transmitting, and/or otherwise communicating data and/or information in a network environment.

The I/O interface(s) 614 allow for input and output of data and/or information with other entities that may be connected to the computer device 600. For example, the I/O interface(s) 614 may provide a connection to arc process system devices and/or components. In some implementations, the I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, the control logic 620 can include instructions that, when executed, cause the processor(s) 602 to perform operations, which can include, but are not limited to: determining motion of the torch 1; changing the operational status of various auxiliary components of the arc process system; providing overall control operations of the arc process system; interacting with other entities, devices, components, systems, etc. described herein; maintaining and/or interacting with stored data, information, parameters, etc. (e.g., the memory element(s) 604, the storage media 606, data structures, databases, tables, etc.); and/or combinations thereof to facilitate various operations for embodiments described herein.

The programs described herein (e.g., the control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Note that in this Specification, references to various features (e.g., elements, structures, nodes, modules, components, engines, logic, steps, operations, functions, characteristics, etc.) included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the torch 1 and trigger module 30 described herein, or portions thereof may be fabricated from any suitable material or combination of materials, such as plastic, foamed plastic, metal, supple natural or synthetic materials including, but not limited to, cotton, elastomers, polyester, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity and does not in itself dictate a relationship between the various embodiments and/or configurations discussed.

Similarly, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate”, etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of”, “one or more of”, “and/or”, variations thereof, or the like are open-ended expressions that are both conjunctive and disjunctive in operation for any and all possible combination of the associated listed items. For example, each of the expressions “at least one of X, Y and Z”, “at least one of X, Y or Z”, “one or more of X, Y and Z”, “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first”, “second”, “third”, etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

What is claimed is:

1. A torch comprising:
a trigger assembly;
a controller electrically coupled to the trigger assembly; and
a motion sensor electrically coupled to the controller,
wherein the controller is configured to transmit a control signal to one or more components of an arc process system in response to motion detected by the motion sensor.

2. The torch of claim 1, wherein the motion sensor is configured to detect motion of the torch and transmit a motion signal indicative of motion of the torch to the controller.

3. The torch of claim 2, wherein the controller determines whether the torch is in a user's hand based on the motion signal from the motion sensor.

4. The torch of claim 1, wherein the one or more components comprise a pump for supplying cooling liquid to the torch, a cooling fan to induce a cooling flow through an interior of a power supply, a gas manifold to charge a gas line fluidly coupled to the torch, a light source, and a trigger for controlling an arc process operation.

5. The torch of claim 4, wherein the control signal activates or deactivates the one or more components.

6. The torch of claim 1, wherein the trigger assembly further comprises a trigger; and
the controller is further configured to prevent the trigger from transmitting a signal when the controller determines the torch is not in motion.

7. The torch of claim 1, wherein the controller is further configured to determine the torch is held in a user's hand based on a motion signal from the motion sensor.

8. A method comprising:
generating, via a motion sensor, a motion signal indicative of motion of a torch;
transmitting, via the motion sensor, the motion signal to a controller;
receiving the motion signal at the controller;
determine, via the controller, whether the torch is moving based on the received motion signal; and
transmitting, via the controller, a control signal to one or more components of an arc process system to activate one or more auxiliary functions.

9. The method of claim 8, wherein the one or more components comprise a pump, a cooling fan, a gas manifold, a light source, and a trigger for controlling an arc process operation.

10. The method of claim 9, wherein the one or more auxiliary functions comprise at least one of:
supplying cooling liquid to the torch via the pump;
inducing a cooling flow through an interior of a power supply of the arc process system via the cooling fan;
illuminating an area via the light source;
charging a gas line fluidly coupled to the torch via the gas manifold; and
a trigger safety for the trigger.

11. The method of claim 8, wherein the one or more auxiliary functions comprise a trigger safety, the trigger safety comprises preventing the trigger from sending an activation signal to the one or more components.

12. The method of claim 8, wherein the one or more auxiliary functions are activated prior to initiation of an arc.

13. A system comprising:
an arc process device comprising one or more components;
a controller electrically coupled to the arc process device; and
a motion sensor electrically coupled to the controller,
wherein the controller is configured to control to the one or more components of the arc process device in response to a motion signal from the motion sensor.

14. The system of claim 13, wherein the arc process device is a torch, and the one or more components is a trigger.

15. The system of claim 14, wherein the controller is further configured to prevent the trigger from initiating an arc process operation based on the motion signal.

16. The system of claim 14, wherein the controller is further configured to allow the trigger to initiate an arc process operation based on the motion signal.

17. The system of claim 16, wherein the motion signal is indicative of the torch being held in a user's hand.

18. The system of claim 14, wherein the motion sensor and the trigger are disposed in a trigger assembly.

19. The system of claim 13, wherein the one or more components comprise at least one of a pump for supplying cooling liquid to a torch, a cooling fan to induce a cooling flow through an interior of a power supply, a light source for illuminating an area, and a gas manifold to charge a gas line fluidly coupled to the torch.

20. The system of claim 19, wherein the arc process device comprises at least one of the power supply, a wire feeder, a cooling unit, a gas supply and/or the torch.
